(19) United States
(12) Patent Application Publication
(10) Pub. No.: US 2019/0173876 A1
(43) Pub. Date: Jun. 6, 2019

(54) STREAMLINED AUTHENTICATION

(71) Applicant: THE MISCELLANEOUS TECHNICAL LIMITED COMPANY LLC, Brookline, MA (US)

(72) Inventor: Jason RAYLES, Brookline, MA (US)

(21) Appl. No.: 15/829,475

(22) Filed: Dec. 1, 2017

(51) Int. Cl. H04L 29/06; G06K 9/62; G06K 9/78

(52) U.S. Cl. CPC H04L 63/0853; H04L 63/083; G06K 2209/27; G06K 9/78; G06K 9/6267

(57) ABSTRACT

The present disclosure provides a method for automatically authenticating a first device through an authentication application on a second device. An image of activation information provided by the first device is received at the second device. A portion of the received image is then classified as one of many known challenge screens. A content provider associated with the received image is identified. Moreover, an authentication address is created based on the activation information found in the received image and the content provider associated with the stored image. The authentication address is then launched in a web browser. Finally, the additional login information of a user is received at the second device, wherein the accessed authentication address automatically authenticates the first device.

### FIELD OF THE INVENTION

The present invention generally relates to user authentication, and more specifically to authentication of a first device by a mobile device.

### BACKGROUND

Content providers restrict access to premium content. The content provider typically requires a user to authenticate their credentials with the user's cable provider, also known as a Multichannel Video Program Distributor (MVPD), or authentication service, before accessing the premium content. Over The Top (OTT) devices allow users to view premium content over the internet. Typically, when an unauthenticated user attempts to play premium content from a specific content provider on an OTT device for the first time and at regular interviews thereafter, the OTT device presents a challenge screen containing an activation code and an activation website address. Both the activation code and the activation website address may be a jumbled set of alphanumeric characters.

To authenticate the user's credentials, the user is forced to navigate the activation website address in a web browser on a second device. The user must input the activation code into an input field on the activation website address and then select his authentication service from a list. The activation website can work with an intermediary to transmit the user's information to an authentication service's website. At the authentication service's website, the user must input his credentials to verify ability to access the premium content. The authentication service will check for the user's authorization to access the premium content and, if the user's credentials can be verified, the authentication service will forward the authorization through the intermediary. Finally, the user will be taken to a success screen notifying the user that he has successfully authorized his first device.

This process is onerous and prone to user drop off, such that the user might abandon the process rather than completing all the steps required to authenticate the first device and continue to the premium content. Typically, the URL of the activation form is difficult to navigate because a user may mistype any of the jumbled alphanumeric characters listed in the web address. Furthermore, users may have trouble correctly inputting the jumbled alphanumeric characters of the activation code. Even in the event the user is able to navigate the URL and input the activation code, successful submission of an activation form accessed through the activation website address requires specific cookie permissions in the user's browsers. Thus, if these specific cookie permissions are not met, the user must change his browser settings, and then restart the process. Users generally are unfamiliar with the cookie settings on their browsers and unaware of how best to change the permissions. Additionally, the number of steps required to verify the first device can be time prohibitive for some users who may lose interest and choose to watch something else that does not require authorization. Lastly, users may need to do this process numerous times for separate applications and may encounter the same difficulties repeatedly.

### SUMMARY

Systems and methods in accordance with various examples of the present disclosure provide a solution to the above-mention problems through an authentication application to streamline authentication of the user. The authentication application uses camera functionality of a second device to detect a challenge screen on the first device. The authentication application automatically identifies which content provider is requesting authentication through classifying the detected challenge screen within a set of challenge screens from different first-screen applications. The authentication application then constructs an authentication website address. The authentication website address includes necessary activation information for the user such that user only needs to provide his credentials to his authentication service.

The authentication application is advantageous because the user does not need to input anything related to the activation website address and activation code listed on the challenge screen displayed on the first device. Instead of the user entering the codes, the activation application can automatically detect them and construct authentication addresses so that the user does not need to type addresses or codes himself. The authentication application bypasses the content provider's activation website entirely so that the user never needs to interact with it. Additionally, the authentication application solves the problem of the user needing to verify his cookie settings because the authentication application bypasses the step where the user enters the activation code.

For purposes of the present detailed description, the words “challenge screen” mean the display that an unauthenticated device displays when an unauthenticated user attempts to view premium content on the device. The challenge screen can contain an alphanumeric activation code and the website address of an activation form.

For purposes of the present detailed description, the words “first device” refer to the electronic media system, whether an application on the device or the physical device itself, that the user is attempting to authenticate. Exemplary embodiments can include a smart TV, AppleTV, Roku, over the top device, set-top box, net-top box, digibox, gaming console, and other similar devices.

For purposes of the present detailed description, the words “second device” refer to the electronic device that the user must operate in order to authenticate his credentials. This second device must contain a camera and is a distinct device from the first device.

For purposes of the present detailed description, the words “activation website address” refer to the web page displayed when a device accesses the website address listed on the challenge screen.

In accordance with one aspect of the present disclosure, a computer-implemented method for authenticating a user to view a content provider's premium content on a first device, comprises: (1) receiving with the second device an image of activation information displayed on the first device; (2) classifying a portion of the received image as one of many known challenge screen images; (3) identifying a content provider associated with the known image; (4) creating an authentication address based on activation information found in the received image and the user's previously stored authentication service identifier; (5) launching the authentication website address in a web browser, (6) receiving, at the second device, additional login information of a user, wherein the accessed authentication address automatically authenticates the first device.

In some examples, the authentication application can automatically access a camera on the second device and detect whether the camera is facing an image of activation information from a content provider. The camera can automatically receive the image of activation information. The received image of activation information can include an activation code, an activation website address, and a requestor identification of an application requesting authentication on the first device.

The authentication application can process the received image of activation information to detect the activation code, the activation website address and the requestor identification. The application can verify the discovered activation code to check that it was correctly detected.

The application can store a database of image metadata either on the second device or on a remote server. This database of stored metadata can contain image features and feature coordinates of challenge screen to enable classifying the received image with a known image. The application can perform this functionality on the second device or it can employ a client-server architecture where the received image is uploaded to a remote server for processing. The application can also store on the second device or on a remote server which content providers' material a user should have access to.

If the authentication application cannot automatically deliver the user to the authentication website address, the authentication application can detect an activation code and activation website address from the received image. The application can copy the activation code to the clipboard of the second device and transport the user to a web browser. The application can automatically load the activation website address such that the user can just copy the activation code into the appropriate form on the website.

Additional features and advantages of the disclosure will be set forth in the description which follows, and in part, will be obvious from the description, or can be learned by practice of the herein disclosed principles. The features and advantages of the disclosure can be realized and obtained by means of the instruments and combinations particularly pointed out in the appended claims. These and other features of the disclosure will be more fully apparent from the following description and appended claims, or can be learned by the practice of the principles set forth herein.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof, which are illustrated in the appended drawings. These drawings depict only example aspects of the disclosure, and are not therefore to be considered to be limiting of its scope. The principles herein are described and explained with additional specificity and detail through the use of the accompany drawings in which:

FIG. 1 is a schematic block diagram illustrating an exemplary traditional workflow for a user to authenticate a first device with a second device;

FIG. 2 is an exemplary illustration of an authentication system;

FIG. 3 is an exemplary diagram of a challenge screen configuration;

FIG. 4 is an exemplary illustration of a contemporary challenge screen configuration;

FIG. 5 is a schematic block diagram of a second device; and

FIG. 6 is a schematic block diagram illustrating an exemplary method for automatically authenticating a user's first device through an authentication application on a second device.

### DETAILED DESCRIPTION

The present disclosure can be embodied in many different forms. Representative embodiments are shown in the drawings and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed: the singular includes the plural and vice versa; and the word “including” means “including without limitation.” Moreover, words of approximation, such as “about,” “almost,” “substantially,” “approximately,” and the like, can be used herein to mean “at, near, or nearly at,” or “within 3-5% of,” or “within acceptable manufacturing tolerances,” or any logical combination thereof, for example.

Various examples of the present disclosure provide methods for automatically authenticating a user's first device through an authentication application on a second device. As an initial matter an image of activation information provided by the first device is received at the second device. A portion of the received is then classified as one of many known challenge screen images. A content provider associated with the known image is identified. Moreover, an authentication address is created based on the activation information found in the received image and the user's previously stored authentication service identifier. The authentication address is then launched in a web browser. Finally, the additional login information of a user is received at the second device, wherein the accessed authentication address automatically authenticates the first device.

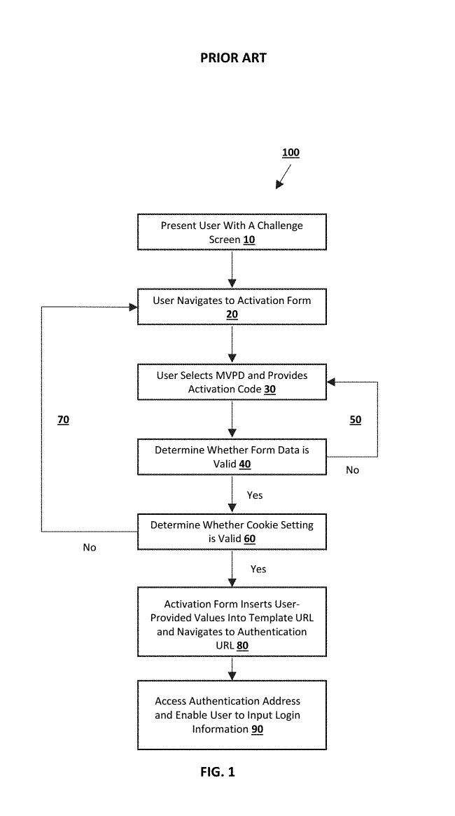

FIG. 1 is a schematic block diagram illustrating an exemplary traditional method 100 of illustrating the process of a user authenticating a first device with a second device. At step 10, the first device displays a challenge screen when an unauthenticated user attempts to access premium content from a content provider on a new or unauthenticated device. At step 20, the user operates a second device to navigate to the website address listed on the challenge screen. At step 30, the user selects the content provider to authenticate, provides the activation code listed on the challenge screen, and manually inputs any other required form data. For example, the website may request the type of device the user is attempting to authenticate.

The content provider's authentication protocol will then verify whether the activation code entered by the user is valid at step 40. If the code is found to be invalid, method 100 will advance to step 50 where the user will be required to repeat step 30. If the code is found to be valid, the content provider's authentication protocol verifies whether the user's web browser's cookie settings are valid for the content authentication protocol at step 60. If the cookie settings are found to be invalid, method 100 will advance to step 70 where the user will be required to return to step 20 where the user operates a second device to navigate to the website address listed on the challenge screen. If the cookie settings are found to be valid at step 60, the content provider's activation form will insert the user-provided values into a template URL and navigate to an authentication URL at step 80. At step 90, the user can be able to enter login information for the authentication service and then view the premium content.

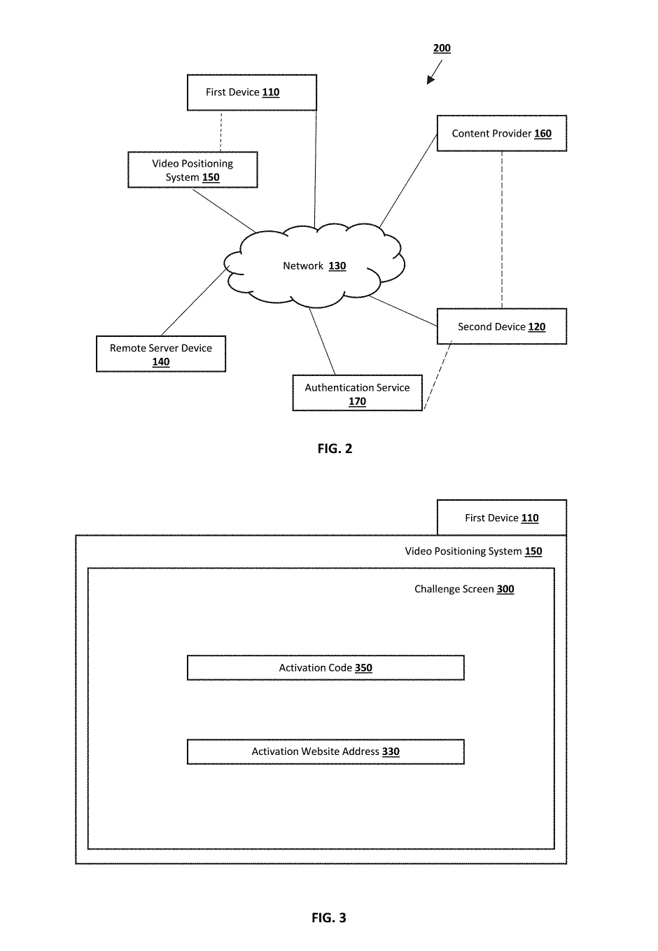

FIG. 2 illustrates an exemplary embodiment of a system 200 for automatically authenticating a user's first device through an authentication application on a second device. The system 200 includes a first device 110, a second device 120, a network 130, a remote server device 140, a video positioning system 150, and a content provider 160. It should be noted that the exemplary system 200 provides the enumerated components for example; one of ordinary skill in the arts will note that every component listed herein is not required, nor is the list of components herein meant to be exhaustive. The first device 110 can include an OTT platform, which attaches to the video positioning system 150. The first device 110 can access the premium content by syncing to an authentication service 170 over the network 130 and providing user credentials. The second device 120 can provide networking service to authenticate the first device 110.

This network 130 can be a local area network (LAN), a wide area network (WAN), virtual private network (VPN) utilizing communication links over the internet, for example, or a combination of LAN, WAN and VPN implementations can be established. For the purposes of this description, the term network should taken broadly to include any acceptable network architecture. For the purposes of this embodiments, the network 130 interconnects the first device 110, second device 120, remote server device 140, video positioning system 150, and the authentication service 170. However, it should be noted that any combination of components can communicate over a separate or distinct network not listed herein.

The first device 110 can communicate to the authentication service 170 through the network 130. The second device 120 can access the authentication form of the authentication service 170 through the network 130. The second device 120 can also access any content stored on the remote server device 140 through the network 130. The first device 110 can communicate with the video positioning system 150 and can tell the video positioning system 150 what content to display. The first device 110 also communicates with the authentication service 170 through the network 130 to identify whether the user has authorization to display the content requested by the user.

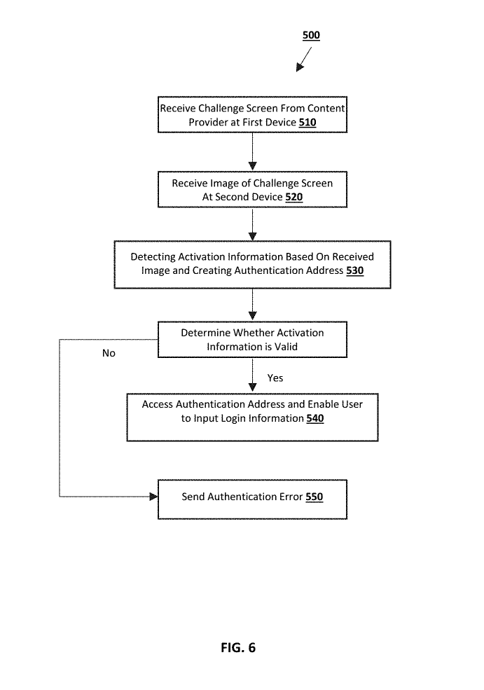

The remote server device 140 can be configured to connect with the second device 120 through the network 130. The second device 120 can connect with the remote server device 140 to store information to assist in the authentication process. For example, the remote server device 140 can store images of login information, what type of device the user is operating as the second device or the first device, what content providers the user should have access to, and any other information that could improve the performance of the authentication application. The remote server device 140 can also store a database of known image features corresponding to challenge screens for various content providers. This database will be discussed in detail in relation to step 530 of FIG. 6.

In some embodiments, the video positioning system 150 can be configured to visually display the premium content once the content has been authenticated. For example, the video positioning system 150 can include a television, a mobile device, a tablet, or a computer monitor. Examples of the video positioning system 150 are provided herein as a demonstrative and are not intended to be an exhaustive list. The video positioning system 150 can be configured to receive instructions on displaying content from the first device 110.

The content provider 160 can communicate through the network 130 with the first device 110. In some embodiments, the content provider 160 can send the content to the first device 110. Furthermore, the content provider 160 can send both content that any user can access and content that only certain users can access. When the content provider 160 sends material that only certain users can access, the first device 110 will need to authenticate the user. During the period of authentication, the content provider 160 and the first device 110 can communicate periodically through the network 130 to validate whether the user has been authenticated by the content provider 160. When the user has been authenticated, the content provider 160 can provide this information to the first device 110. The first device can then allow the video positioning system 150 to display content.

The second device 120 can communicate with the remote server device 140 through the network 130. The second device 120 can access information on the remote server device 140. In some embodiments, the second device can access known image features of challenge screens, the type of device the user is operating as the second device or the first device, the content providers the user has access to, and any other information stored on the remote server device 140.

FIG. 3 is an exemplary illustration of a challenge screen 300 located on the video positioning system 150. The first device 110 can be connected to the video positioning system 150 through any physical electrical connection such as an HDMI cord or USB port. The first device 110 can also be connected to the video positioning system 150 through a network adapter. A physical connection would allow the first device 110 to pass content viewing data physically to the video positioning system 150. A network adapter can configure the video positioning system 150 to connect to the network 130 to receive content, temporarily store the received content, and then display the content. In some embodiments, the first device 110 can determine whether the user has authorization to view the content. In some embodiments, the first device 110 can send the content ready for viewing to the video positioning system 150. In alternative embodiments, the first device 110 can send a challenge screen 300 requiring authentication.

The challenge screen 300 is an exemplary layout of the content provider's 160 challenge screen as displayed on the video positioning system 150. In some embodiments, the first device 110 can display a challenge screen 300 at the video positioning system 150 when the first device 110 attempts to access premium content from the content provider 160. The content provider's challenge screen 300 can vary in its visual layout to include the branding and graphic design of the content provider 160. The challenge screen 300 can also contain an activation website address 330 to indicate that the user should navigate to that address on the second device 120 in order to authenticate the first device 110. The challenge screen can also contain an activation code 350 and directions to put the activation code 350 in a specific location on the content provider's activation form.

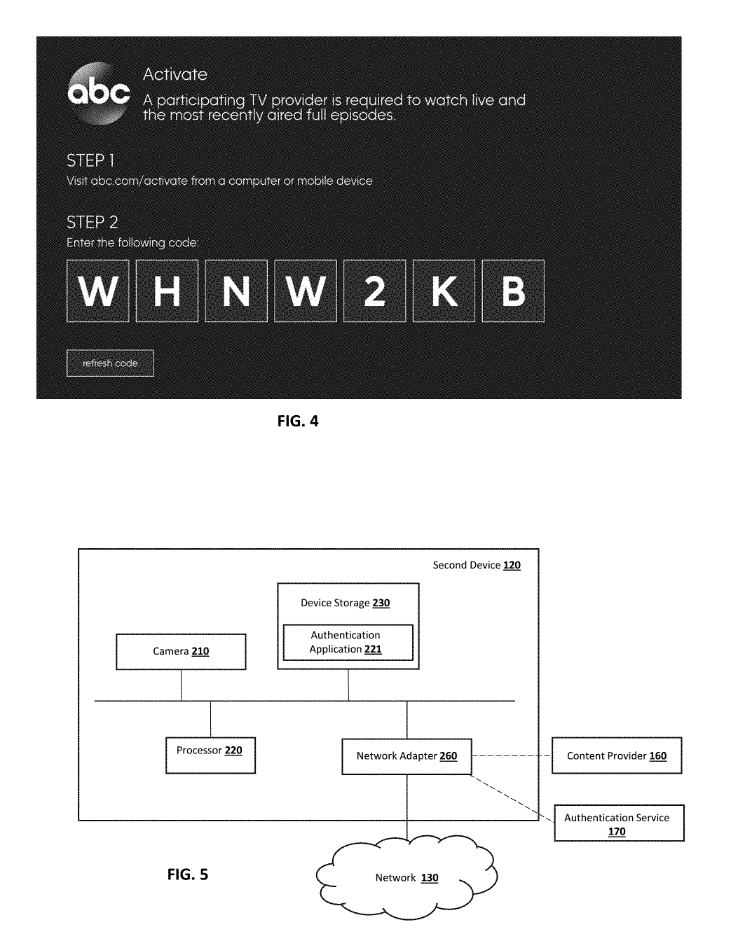

FIG. 4 is an image of a contemporary challenge screen. Challenge screens can vary in their color and branding.

FIG. 5 illustrates a schematic block diagram of the second device 120. The second device 120 can include a camera 210, a processor 220, device storage 230, and a network adaptor 260 configured to connect to the remote server device 140 of FIG. 2. The device storage 230 can be configured to store the authentication application 221. The processor 220 can be configured to run the authentication application 221. The camera 210 is connected to the processor 220 to send captured images to the processor 220 for processing.

In some embodiments, the camera 210 can be configured to capture an image of the challenge screen 300 (shown in FIG. 3). The camera 210 can operate concurrently with the authentication application 221 stored on the device storage 230 to analyze and identify the captured image from the camera 210.

In some embodiments, the authentication application 221 can instantly open to the camera 210 on the second device 120. The authentication application 221 can run concurrently with the camera 210 such that the camera 210 can automatically detect if the camera 210 faces a challenge screen 300. The camera 210 can automatically capture the image and send it to the authentication application 221 for processing.

In other embodiments, the user opts to go to the camera 210 after accessing the authentication application 221. The user can then determine when to capture challenge screen 300. The authentication application 221 can then verify the activation website address 330 and the activation code 350 are legible and able to be read by the authentication application 221. In an alternative embodiment, the user can open the camera 210 after opening the authentication application 221, where the camera 210 automatically detects the challenge screen 300 and captures the image.

The processor 220 can be a self-contained computing system to process commands during user interaction. For example, the processor 220 can operate to run the camera 210 and indicate when the camera 210 should capture an image. The processor 220 can open the authentication application 221 from device storage 230. The processor 220 can run commands to further access device storage 230 for information that the authentication application 221 needs when authenticating with the content provider 160.

The received image of the challenge screen 300 can contain a variety of data as shown in FIG. 3, including an activation code 350, an activation website address 330. The challenge screen 300 can include additional information. For example, the challenge screen 300 can include the application requesting authentication on the first device, and any instructions for the user on how to authenticate the first device. The authentication application 221 can analyze the received image through the processor 220 to detect the individual pieces of information and store them on the second device 120. The information may be stored in the device storage 230.

The authentication application 221 can also authenticate the discovered activation code using the processor 220 to calculate the Cartesian product of all likely substitutions. Furthermore, the authentication application 221 can periodically verify the activation code. The second device 120 can be configured to communicate and receive data from the remote server 140 over the network 130 via the network adaptor 260. Examples of this data include known image features of challenge screens, what type of device the user is operating as the second device or the first device, what content providers the user should have access to, and any other information stored on the remote server device 140.

The second device 120 can also access the activation website address 330 provided by the content provider 160 on the challenge screen 300 (shown in FIG. 3). The processor 220 may accept data from the authentication application 221 to provide to the activation website address 330 of the content provider 160. Examples of data include the activation code 350 provided by the content provider 160 on the challenge screen 300 (shown in FIG. 3). Providing the activation code 350 to the content provider 160 is a step towards authenticating the user.

FIG. 6 is schematic block diagram illustrating an exemplary method 500 for automatically authenticating the first device 110 through an authentication application 221 stored on the second device 120. FIG. 6 is explained in detail with respect to components introduced and discussed in FIGS. 1-4.

As an initial matter, the authentication application 221 can receive data related to a template website address. The template website address can enable a user to navigate directly to the authentication service 170. This allows a user to avoid entering the activation website address 330 and the activation code 350 into the browser, as described above with respect to FIG. 1. A template website address can contain the activation website address 330 and the activation code 250 in the URL query to automatically authenticate the user. The template website addresses can be processed offline and stored. The template website addresses can enable the authentication application 221 to create an authentication address that will be accepted by the authentication service 170 and integrate the activation information from the first device 110.

In some embodiments, the authentication service 170 that the user is authorized to use can be selected from a list in the authentication application 221. The authentication application 221 can request the user for any other information known to be required by authentication service's 170 authentication protocols. The authentication application 221 can store this information for automatic population into a form. At step 510 of FIG. 6, the first device 110 can receive a challenge screen 300 in response to requesting access premium content from a content provider 160. At step 520, the second device 120 can receive an image of the challenge screen 300 via the authentication application 221.

At step 530, the authentication application 221 detects the activation information from the received image of the challenge screen 300. The authentication application 221 identifies which content provider 160 has displayed the challenge screen 330. In order to identify the content provider 160, the authentication application 221 classifies a portion of the received image as one of many known challenge screens. The known challenge screens are processed to identify unique image features. Metadata of the unique image features can be stored on the second device's device storage 230 or can be stored on the remote server device 140. The metadata can be used to classify a portion of the received image as one of the many known challenge screens. The received image can be an image from the camera 210 of the second device 120.

When the authentication application 221 determines the challenge screen that corresponds with the received image, the authentication application 221 can determine the content provider 160 associated with the stored image. Based on the determined content provider, the authentication address can be created to authenticate the first device. In order to create the authentication address at step 540, the authentication application 221 can receive a template website address for the determined content provider 160. The authentication application 221 can also retrieve stored authentication data for the user. The authentication application 221 can create an authentication address based on the activation information detected from the received image and the identity of the content provider 160.

The content provider's authentication protocol can determine whether the data is valid. If the data is found to be invalid, the authentication application will send an error description at step 550. The error description can be displayed on the second device 120, or the first device 110. The authentication application can request the user to correct the information determined to be incorrect. In some embodiments, the received image cannot be matched to a stored image. This can occur where the received image is from a content provider and the content provider does not have a corresponding image in the stored image database. This can also occur if the received image is of a low quality.

In the event that the activation information is determined to be invalid and the application cannot automatically deliver the user to the authentication URL, the authentication application will deliver an error message to the user in step 550. In some embodiments, the authentication application 221 copy the activation code 350 to the clipboard of the second device 120 and send the user to a web browser. This would allow the user to more easily proceed with the authentication process.

If the data is found to be valid by the authentication application 221, the application can proceed to step 540. At step 540, the authentication application 221 can navigate to the authentication address for the user, accept the login information for the content provider 160, and automatically authenticate the first device 110.

Based on the technology and teachings provided herein, a person of ordinary skill in the art will appreciate other ways and/or methods to implement the various aspects of the present disclosure. The specification and drawings are, accordingly, to be regarded in an illustrative rather than restrictive sense. It will, however, be evident that various modifications and changes can be made thereunto without departing from the broader spirit and scope of the patent application, as set forth in the claims.

What is claimed is:

1. A computer-implemented method for automatically authenticating a first device by operating a second device, comprising:
receiving, at the second device, an image of activation information provided by the first device;
identifying a content provider associated with a received image;
creating an authentication address based on activation information found in the received image and the content provider associated with the stored image;
launching the authentication address in a web browser;
receiving, at the second device, additional login information of a user, wherein the accessed authentication address automatically authenticates the first device.

2. The computer-implemented method of claim 1, further comprising:
accessing a camera on the second device;
detecting whether the camera is facing an image of activation information from a content provider;
automatically capturing the image of activation information.

3. The computer-implemented method of claim 1, further comprising:
wherein the received image of activation information includes an activation code, an activation website address, and a requestor identification of an application requesting authentication on the first device.

4. The computer-implemented method of claim 3, further comprising:
processing the received image of activation information to detect the activation code, the activation website address, and the requestor identification; and
verifying the discovered activation code by confirming its validity through a network connected application programming interface provided by an authentication service.

5. The computer-implemented method of claim 1, further comprising:
classifying a portion of the received image as being one of many known challenge screens.

6. The computer-implemented method of claim 5, further comprising:
wherein metadata of the many known challenge screens is stored on a remote server.

7. The computer-implemented method of claim 1, further comprising:
storing on the second device or on a remote server which content providers' material a user should have access to.

8. The computer-implemented method of claim 1, further comprising:
wherein the additional login information of a user is the user's login information for the content provider that owns the content that the first device is requesting authentication to display.

9. A system for automatically authenticating a first device by operating a second device, the system comprising:
a first device configured to access a content provider's premium content;
a second device configured to:
receive an image of activation information provided on the first device;
identify a content provider associated with the received image;
create an authentication address based on activation information found in the received image and the content provider associated with a known image;
launch the authentication address in a web browser;
receive, at the second device, additional login information of a user, wherein the accessed authentication address automatically authenticates the first device.

10. The system of claim 9, wherein the second device is further configured to:
classify a portion of the received image as being one of many known challenge screens, wherein metadata of known challenge screen are located on the second device.

11. The system of claim 9, wherein the second device is further configured to:
access a camera on the second device;
detect whether the camera is facing an image of activation information from a content provider;
automatically capture the image of activation information.

12. The system of claim 9, wherein the second device is further configured to:
receive an image of activation information including an activation code, an activation website address, and a requestor identification of an application requesting verification on the first device.

13. The system of claim 11, wherein the second device is further configured to:
process the received image of activation information to detect the activation code, the activation website address, and the requestor identification; and
verify the discovered activation code by confirming its validity through a network connected application programming interface provided by the authentication service.

14. The system of claim 9, wherein the system further includes:
a remote server configured to store image metadata.

15. The system of claim 9, wherein the second device and the remote server are further configured to:
store which content providers' material a user should have access to.

16. The system of claim 9, wherein the second device is further configured to:
receive additional login information of a user comprised of the user's login information for the content provider owning the content that the first device is requesting authentication to display.

17. The system of claim 9, wherein the second device is further configured to:
detect an activation code from the received image; and
copy the activation code to the clipboard of the second device.
transport the user to a web browser and automatically load an activation website address detected from the received image.

18. A computer-implemented method for automatically authenticating an over-the-top device by operating a mobile device, comprising:
receiving, at the mobile device, an image of a challenge screen provided by the over-the-top device;
identifying a content provider associated with the received image;
creating an authentication address based on activation information found in the received image and the content provider associated with the stored image;
launching the authentication address in a web browser;
receiving, at the mobile device, additional login information of a user, wherein the accessed authentication address automatically authenticates the over-the-top device.

19. The computer-implemented method of claim 18, wherein the method further comprises:
classifying a portion of the received image as being one of many known challenge screens.
